(19) United States
(12) Patent Application Publication
(10) Pub. No.: US 2002/0011161 A1
(43) Pub. Date: Jan. 31, 2002

(54) Device for releasable attachment of a conveyor belt carrier of a printing press

(76) Inventors: Lennardt Jader, Strande (DE); Lutz Rebetge, Kiel (DE)

Correspondence Address: Lawrence P. Kessler, Patent Department, NexPress Solutions LLC, 1447 St. Paul Street, Rochester, NY, 14653-7103, US

(21) Appl. No.: 09/850,174

(22) Filed: May 7, 2001

(30) Foreign Application Priority Data
May 18, 2000 (DE) 100 24 093.3
Dec. 1, 2000 (DE) 100 59 888.9

(51) Int. Cl. B41F 1/00; B41F 13/24

(52) U.S. Cl. 101/232

(57) ABSTRACT

The invention concerns a device for releasable attachment of a conveyor belt carrier (1) of a printing press (2), the conveyor belt carrier serving for the transport of printing substrates (3) is capable for moving away from the operating elements (4) interacting with it for service purposes.

This device is to be improved in such a way that the conveyor belt carrier can be moved away simply and returned into the operating position exactly. This is achieved by the fact that the conveyor belt carrier (1) is coupled to the printing press (2) capable of swiveling on a longitudinal side (5) in such a way that in it is capable of swiveling (8) in at least one service position (6, 6′) and one operating position (7) and being fastened in the latter.

### DESCRIPTION

The invention concerns a device for the releasable attachment of a conveyor belt carrier of a printing press, wherein it is possible to move the conveyor belt carrier serving for the transport of printing substrates for service purposes away from the functional elements connected with it.

Conveyor belt carriers essentially serve for holding a conveyor belt, guides of the same, a drive, and for the most part also control and sensor elements, as well as elements which provide for pressing forces on cylinders. The printing substrates guided by the conveyor belt can be detected metrologically or processed by the printing press. In addition operating elements, which work together with the conveyor belt for the above-mentioned purposes, are found above the guided printing substrate. In the case of a printing press, as a rule of an electrographic printing press, there are printing modules, which print the printing substrates by means of cylinders with partial color images, which together produce the color printing. In addition, naturally, also there may be further sensor, control, or processing elements.

For service operations it is necessary to separate the conveyor belt carrier with the conveyor belt from the above-mentioned functional elements. For example, this may be used for eliminating a paper jam, changing the conveyor belt, or approaching functional element which are located in this area. For this purpose it was proposed that the machine parts located above the conveyor belt carrier be folded away. This is not practicable in particular in the case of precision machines, in which these machine parts have a certain size. Also it was proposed that the conveyor belt carrier be made removable or to moved away from the machine by means of vertical or horizontal guides. The last-named proposals also are not practicable in the case of large machines, in particular when the conveyor belts and therefore also the carriers thereof have a certain length. In each case conveyor belt carriers of the above-mentioned type are hard to handle and therefore for the most part can be handled only by trained service technicians and not by operating persons. In the case of these solutions it also is difficult to position a conveyor belt carrier for the operating position again, for the most part an adjustment must be made.

Therefore the object of the invention is to made a device of type mentioned initially in such a way that the conveyor belt carrier can be moved away simply and returned exactly into the operating position.

The object is achieved according to the invention by guiding the conveyor belt carrier on a longitudinal side capable of swiveling on the printing press in such a way that it is capable of swiveling into at least one service position and one operation position and capable of being fixed in the latter.

By means of the swivel motion according to the invention heavy, long conveyor belt carriers can be moved away in a simple way, in order to remove a paper jam, to change the conveyor belt, or perform service work. An operating person also can remove a paper jam by moving the conveyor belt carrier away or performing simple service work by simple handling. In this way many problems can be eliminated rapidly and without time loss. However, the easier accessibility of the machine is advantageous also for major service operations.

A particularly great advantage of the invention consists in the fact that the swivel motion makes it possible to swivel the conveyor belt carrier again exactly into its operating position. In this way adjusting work is eliminated since the swivel motion is exactly possible in such a way that the effect lies within a range which can be corrected by means of an automatic register corrector of a printing press. Precisely this fact also makes it possible for operators of the machine to perform such an action, for example to remove a paper jam. However the design according to the invention, in addition to printing presses, is advantageous for all printing machines and makes simple and good accessibility to many parts of the machines parts.

Advantageously at least one stop is prepared by means of which the working position is exactly defined. In this way it is possible to find this position within the shortest tolerances and in this case to achieve an absolutely parallel position. Furthermore it is proposed that at least one locking device serves for fastening the conveyor belt carrier in the working position. In this way high pressing forces, which are necessary, for example, for quality printing, can act on the conveyor belt.

A improvement of the invention provides that at least one element supporting the swivel motion is provided. This element is designed advantageously in such a way that the conveyor belt has a holding contact in each position and/or that is can be fastened in each position.

An element supporting the swivel motion can consist of at least one spring, for example a gas pressure spring. However, the elements named with their different functions can be combined with one another, for example springs and lockable shock absorbers. In this way the conveyor carrier belt can be moved into different service positions in addition to the working position, and locked there in order to achieve different accessibilities for different operations.

The invention is explained below by means of the drawing. Here:

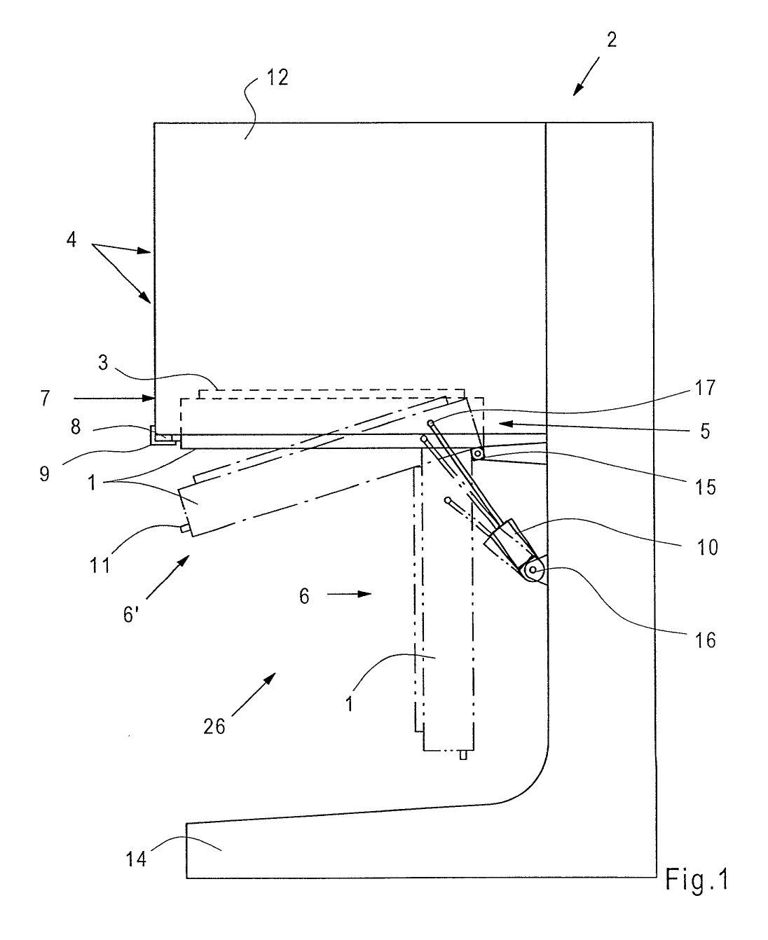

FIG. 1 shows a cross-section of an electrophotographic printing press with an embodiment of a device according to the invention and

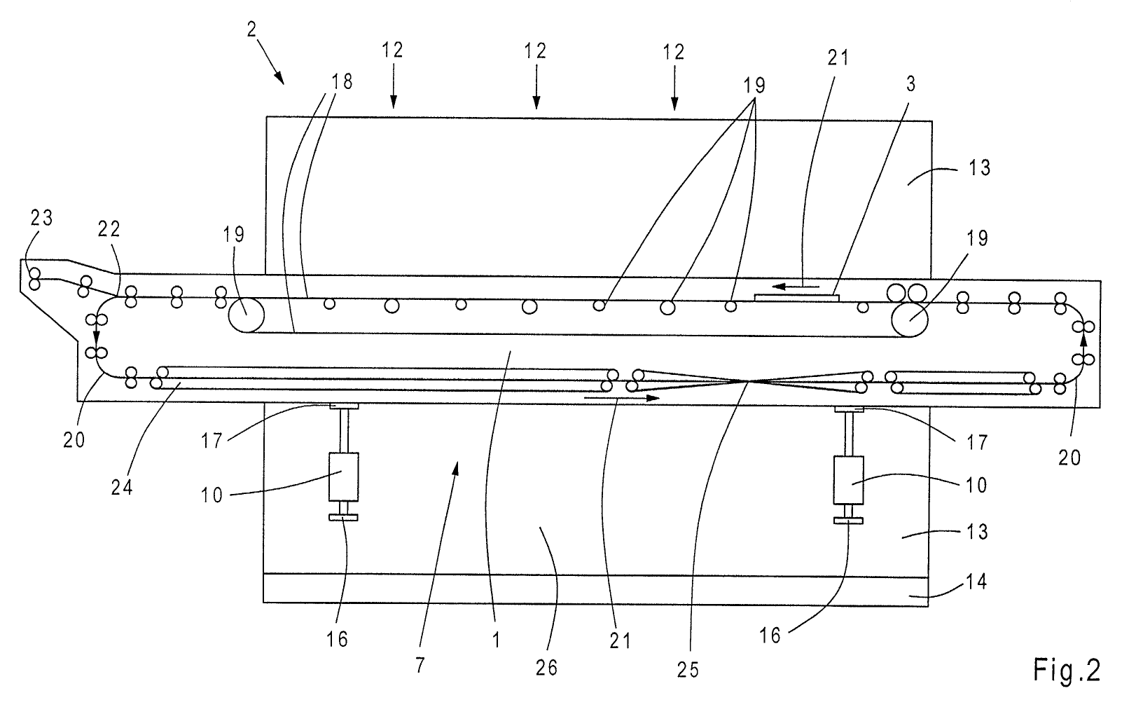

FIG. 2 shows the electrophotographic printing press according to FIG. 1 in a side view with a conveyor belt carrier arranged according to the invention.

FIG. 1 shows a cross-section of a printing press 2 with the coupling 15 of a conveyor belt carrier 1 to the machine housing 13. The printing press 2 is an electrophotographic printing press, in the case of which printing modules 12 are located above the conveyor belt carrier 1. The machine housing 13 extends in L-shape downward from these printing modules 12 and has a foot 14 there. This produces an open space 26, in which the conveyor belt carrier 1 connected to the machine housing 13 on its longitudinal side 5 can be swiveled. In this case the upper horizontal position is the working position 7. All other positions 6, 6′ are service positions, the lowest position 6 providing the best accessibility for large operations. However, all other intermediate positions are possible. Service positions 6, 6′ make it possible to remove paper jams, to change the conveyor belt, or to reach operating elements 4, which may be the printing modules 12 or other operating elements 4, which interact with the conveyor belt 18.

At least one stop 18 and at least one locking device 9 provide for positioning the conveyor belt 1 securely and exactly in its operating position 7. The stopping arrangement 9 is only shown symbolically, it may be made in different ways. For example it can be an opposed bearing 11 of the locking device 9, which is located on the conveyor belt carrier 1. In this way high forces can act on the conveyor belt carrier 1, which is necessary in particular when printing of printing substrates 3 is performed.

In order to bring the conveyor belt carrier 1 into its different positions, 6, 6′, 7, it is advantageous if there is an element 10 which supports the swivel motion. This may be a spring, a gas pressure spring, a damping element or an element which can be locked. The figure shows a gas pressure spring, which has a coupling 17 on the conveyor belt carrier 1 and a coupling 16 on the machine housing. The conveyor belt carrier 1 can be moved upwards easily and in the reverse direction it slows down an independent or too rapid motion of the conveyor belt carrier downward, when the locking device 9 is released. The element 10 also can be made so that the conveyor belt carrier has a self-stop in each position. A locking mechanism also can be provided. This makes it possible always to bring the conveyor belt carrier 1 into the position for service work which is most advantageous and to fasten it there if necessary.

FIG. 2 shows a side view of the electrophotographic printing press 2 according to FIG. 1 with a conveyor belt carrier 1, which is shown cut lengthwise. The description above is to be consulted with respect to the elements already described for FIG. 1. In this representation the conveyor belt carrier 1 is shown in greater detail, however in this case it is a basic diagram in which, for example, paper supplies, paper feed, and other components were omitted for the sake of simplicity. Basically the paper track 20, which is made as a conveyor belt 18, in areas in which it works together with the printing modules 12. This belt is guided by guide rollers 19, at least one of these rollers 19 functioning as a drove roller. In this way the printing substrates 3 are transported in the direction of the arrow 21 and thus printed. After the conveyor belt 18 there is a distributing guide 22, which guides the printed printing substrates 3 either to a sheet discharge 23 or a sheet return 24. The sheet return 24 is for printing the backside of the printing substrates 2, a turning device 125 being mounted or this purpose.

In this representation the conveyor belt carrier 1 is in its operating position and thus is held by the already described locking device 9, which is not shown here.

The drawing contains only one embodiment of the invention, but of course further embodiments are possible. In this case the elements 10, the arrangement of the swiveling or the configuration of stops 8 and locking devices 9 can be made in very different ways.

### Reference Number List

1 conveyor belt carrier

2 printing press, e.g. electrophotographic printing press

3 printing substrate

4 functional elements, which act together with the conveyor belt

5 longitudinal side of the conveyor belt carrier

6, 6′ service positions

7 operating position

8 stop

9 locking device

10 element which supports the swivel motion

11 opposed bearing of the locking device

12 printing module

13 machine housing

14 foot

15 coupling of the conveyor belt carrier on the machine housing

16 coupling of element 10 on the machine housing

17 coupling of element 10 on the conveyor belt carrier

18 conveyor belt

19 guide rollers of the conveyor belt

20 paper web run

21 arrow: machine direction

22 distributing guide

23 sheet discharge

24 sheet return

25 turning device

26 open space

1. A device for releasable attachment of a conveyor belt carrier (1) of a printing press (2), the conveyor belt carrier (1) serving for the transportation of printing substrates (3) is capable of moving away from the operating elements (4) acting together with it for service purposes, wherein the conveyor belt carrier (1) is coupled on the printing press (2) capable of swiveling in a longitudinal side (5), in such a way that it can be swiveled (8) in at least one service position (6, 6′) and one operating position (7) and fastened in the latter.

2. The device according to claim 1, wherein the operating position (7) is exactly defined by at least one stop (8).

3. The device according to claim 1 or 2, wherein at least one locking device (9) serves for fastening the conveyor belt carrier (1) in the operating position (7).

4. The device according to claim 1, 2, or 3, wherein at least one element (10) supporting the swivel motion is provided.

5. The device according to claim 4, wherein the element (10 is made in such a way that the conveyor belt carrier (1) can easily be brought into each position (6, 6′, 7).

6. The device according to claim 4 or 5, wherein the element (10) is made in such a way that the conveyor belt carrier (1) has a holding contact in each position (6, 6′, 7).

7. The device according to claim 4, 5, or 6, wherein the element (10) is made in such a way that the conveyor belt carrier (10 can be fastened in each position (6, 6′, 7).

8. The device according to one of the claims 4 to 7, wherein the element (10) is at least one spring.

9. The device according to one of the claims 4 to 8, wherein the element (10) is at least one gas pressure spring.

10. The device according to one of the claims 4 to 9, wherein the element (1) is at least one lockable gas pressure.

11. the device according to one of the claims 4 to 10, wherein at least two elements (10) of different above-mentioned functions are combined with one another.
